(19) United States
(12) Patent Application Publication
(10) Pub. No.: US 2021/0336289 A1
(43) Pub. Date: Oct. 28, 2021

(54) SOLID ELECTROLYTE AND ALL-SOLID CELL

(71) Applicant: HITACHI, LTD., Tokyo (JP)

(72) Inventor: Norio IWAYASU, Tokyo (JP)

(73) Assignee: HITACHI, LTD., Tokyo (JP)

(21) Appl. No.: 16/322,526

(22) PCT Filed: Jul. 26, 2017
(86) PCT No.: PCT/JP2017/026975

§ 371 Date: Feb. 1, 2019

(30) Foreign Application Priority Data
Aug. 8, 2016 (JP) 2016-155191

(51) Int. Cl. H01M 10/0562; H01M 10/0525

(52) U.S. Cl. CPC H01M 10/0562; H01M 2300/0068; H01M 10/0525

(57) ABSTRACT

In a solid electrolyte to which an imide-based electrolyte salt is applied, corrosion of a current collector of Al is suppressed. A solid electrolyte containing an imide-based Li electrolyte salt, nanoparticles, glyme, and a first additive, wherein the first additive is represented by formula (1) wherein M is any element of nitrogen (N), boron (B), phosphorus (P) and sulfur (S), R is a hydrocarbon group, and Aₙ is BF₄⁻ or PF₆⁻, or an all-solid battery containing the solid electrolyte, a positive electrode, and a negative electrode. Here, the solid electrolyte may contain a second additive.

### TECHNICAL FIELD

The present invention relates to a solid electrolyte and an all-solid battery.

### BACKGROUND ART

In recent years, development of Li batteries has been actively advanced. Development of batteries for electric vehicles is also advanced, and further increase in energy density is demanded for Li batteries. On the other hand, when the energy density of the battery is improved, the safety of the battery becomes a problem. A prior art for improving electrolyte is disclosed as a technique for improving the safety of the battery.

PTLs 1 to 4 disclose a technique in which a liquid electrolytic solution is gelled in an electrolyte. Further, PTL 3 discloses a technique of adding a quaternary ammonium salt to a liquid electrolytic solution. The gel electrolyte of PTLs 1 to 4 is an effective technique for suppressing liquid leakage of the electrolytic solution. However, it is known that it is not a very effective means for improving safety, for example, high temperature storage test, and the like. Improvement of the electrolyte per se is necessary to ensure the safety of the battery during the high temperature storage test.

Therefore, NPL 1 discloses an electrolyte prepared by mixing salts and nanosilica with glyme. Hereinafter, such electrolyte is referred to as a solid electrolyte. The electrolyte of NPL 1 is said to be an electrolyte which is high in heat resistance and effective for high safety of batteries.

### CITATION LIST

### Patent Literature

PTL 1: JP 2008-124031 A
PTL 2: JP H09-235479 A
PTL 3: JP 2014-160608 A
PTL 4: JP H11-238411 A

### Non-Patent Literature

NPL 1: scientific reports, DOI: 10.1038/srep 08869

### SUMMARY OF INVENTION

### Technical Problem

In the battery of NPL 1, stainless steel (SUS) is used for a current collector of a positive electrode. In a normal liquid type Li battery, aluminum (Al) is used for a current collector of a positive electrode. However, when Al is used for the battery of NPL 1, corrosion of Al of the current collector may occur in some cases. This is because it is necessary to use an imide-based electrolyte salt for the electrolyte salt.

LiPF₆ and LiBF₄, which are electrolyte salts currently used in electrolytic solutions, are dissolved in an electrolytic solution and injected into a battery can in which an electrode is wound under an inert atmosphere. Although LiPF₆ and LiBF₄ are very weak against moisture of the outside air, they can be used because they can be handled under an inert atmosphere. In addition, since LiPF₆ and LiBF₄ form a corrosion resistant film of AlF₃ in the current collector of Al, Al can be used as the current collector.

On the other hand, when it is attempted to prepare a battery using the electrolyte of NPL 1 on a large scale, it becomes difficult to handle in an inert atmosphere in terms of costs, so that it is necessary to use an imide-based electrolyte salt that is resistant to atmospheric components. However, there is a possibility that the imide-based electrolyte salt corrodes the current collector of Al and deteriorates battery performance.

An object of the present invention is to suppress corrosion of a current collector of Al in a battery using a solid electrolyte using an imide-based electrolyte salt.

### Solution to Problem

The features of the present invention for solving the above problems are as follows.

A solid electrolyte containing an imide-based Li electrolyte salt, nanoparticles, glyme, and a first additive, wherein the first additive is represented by formula (1) wherein M is any element of nitrogen (N), boron (B), phosphorus (P) and sulfur (S), R is a hydrocarbon group, and Aₙ is BF₄⁻ or PF₆⁻.

[Expression 1]

(M−R)⁺Aₙ⁻ Formula (1)

### Advantageous Effects of Invention

According to the present invention, corrosion of a current collector of Al can be suppressed in a solid electrolyte to which an imide-based electrolyte salt is applied.

### BRIEF DESCRIPTION OF DRAWINGS

FIG. 1 is a cross-sectional view of a lithium secondary battery according to an embodiment of the present invention.

FIG. 2 is a cross-sectional view of a bipolar all-solid battery according to an embodiment of the present invention.

FIG. 3 is a cross-sectional view of a main part of a lithium secondary battery according to an embodiment of the present invention.

### DESCRIPTION OF EMBODIMENTS

Hereinafter, embodiments of the present invention will be described with reference to the drawings and the like. Since the following embodiments are to show specific examples of the present invention, the present invention is not to be considered limited to these embodiments, and various alterations and modifications can be made by those skilled in the art within the scope of the technical idea as disclosed in the present specification. In addition, in all drawings for explaining the present invention, like parts having like functions are designated by like reference numerals without repeating the description thereof.

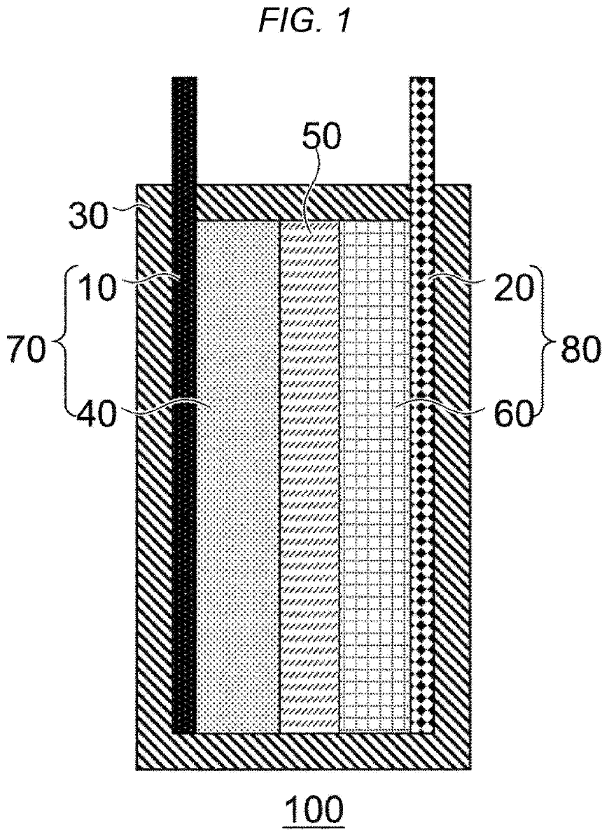

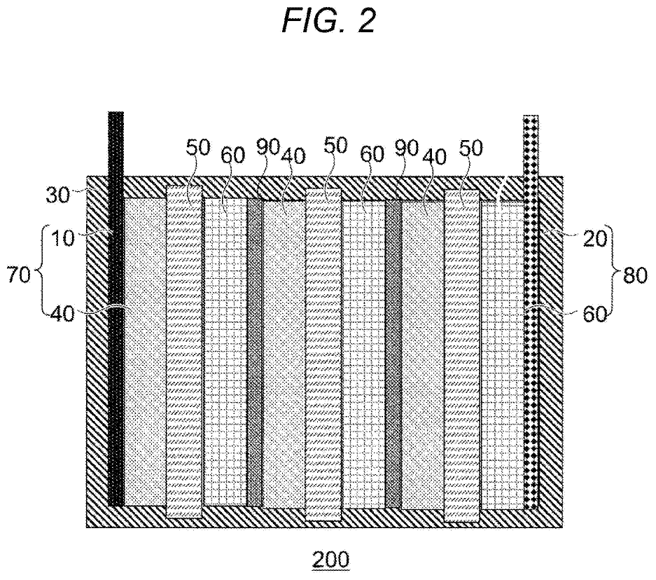

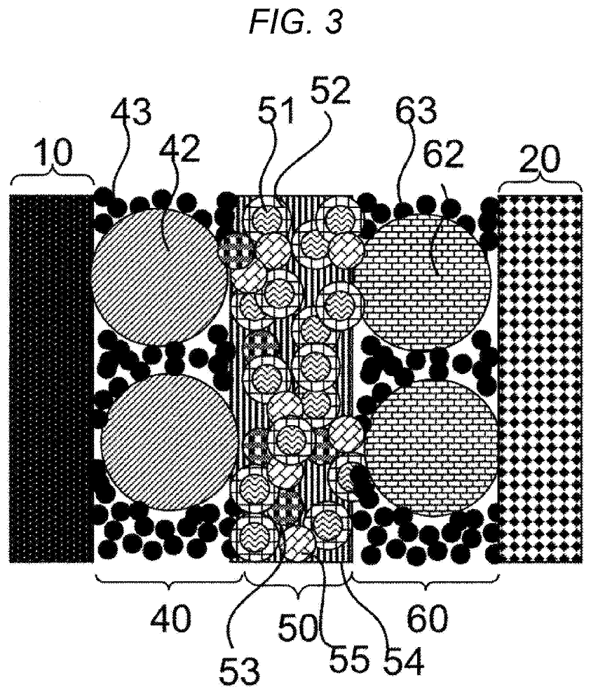

FIG. 1 is a cross-sectional view of an all-solid battery (lithium secondary battery) according to an embodiment of the present invention. FIG. 2 is a cross-sectional view of a bipolar all-solid battery according to an embodiment of the present invention. FIG. 3 is a cross-sectional view of a main part of a lithium secondary battery according to an embodiment of the present invention.

As shown in FIG. 1, an all-solid battery 100 of the present invention has a positive electrode 70, a negative electrode 80, a battery case 30, and a solid electrolyte layer 50. The positive electrode 70 is composed of a positive electrode current collector 10 and a positive electrode mixture layer 40, and the negative electrode 80 is composed of a negative electrode current collector 20 and a negative electrode mixture layer 60.

FIG. 1 is a cross-sectional view of an all-solid lithium battery consisting of a pair of a positive electrode 70, a solid electrolyte layer 50, and a negative electrode 80. However, it can also be a bipolar structure having a constitution in which a positive electrode 70 and a negative electrode 80 are arranged on both sides of one current collector foil. A bipolar all-solid battery 200 of FIG. 2 includes a plurality of layers of a positive electrode mixture layer 40, a negative electrode mixture layer 60, and a solid electrolyte layer 50. In the bipolar all-solid battery 200 in the drawing, the outermost positive electrode mixture layer 40 and the outermost negative electrode mixture layer 60 are connected to a positive electrode current collector 10 and a negative electrode current collector 20, respectively. An interconnector 90 as a current collector is arranged between the positive electrode mixture layer 40 and the negative electrode mixture layer 60 adjacent to each other in a battery case 30.

<Battery Case>

The battery case 30 accommodates the positive electrode current collector 10, the negative electrode current collector 20, the positive electrode mixture layer 40, the solid electrolyte layer 50, and the negative electrode mixture layer 60, the interconnector 90 (FIG. 2 only). The material of the battery case 30 can be selected from materials having corrosion resistance to nonaqueous electrolyte, such as aluminum, stainless steel and nickel plated steel.

<Interconnector>

In the bipolar all-solid battery 200 of FIG. 2, the interconnector 90, which is a current collecting material arranged between a negative electrode 80 and an adjacent positive electrode 70 adjacent to each other, has high electronic conductivity and has no ion conductivity, and the surfaces in contact with the negative electrode mixture layer 60 and the positive electrode mixture layer 40 do not exhibit oxidation-reduction reaction depending on their respective potentials. Materials that can be used for the interconnector 90 include materials that can be used for the following positive electrode current collector 10 and negative electrode current collector 20. Specific examples include aluminum foil and SUS foil. Alternatively, it is also possible to bond the positive electrode current collector 10 and the negative electrode current collector 20 by clad molding and electronic conductive slurry.

<Positive Electrode Mixture Layer>

As shown in FIG. 3, the positive electrode mixture layer has positive electrode active material particles 42, a positive electrode conductive agent 43 which can be optionally contained, and a positive electrode binder which can be optionally contained.

Examples of the positive electrode active material particles 42 include LiCoO₂, LiNiO₂, LiMn₂O₄, LiMnO₃, LiMn₂O₃ LiMnO₂, Li₄Mn₅O₁₂, LiMn₂₋ₓMₓO₂ (wherein M is at least one selected from the group consisting of Co, Ni, Fe, Cr, Zn and Ti, and x=0.01 to 0.2), Li₂Mn₃MO₈ (wherein M is at least one selected from the group consisting of Fe, Co, Ni, Cu and Zn), Li₁₋ₓAₓMn₂O₄ (wherein A is at least one selected from the group consisting of Mg, B, Al, Fe, Co, Ni, Cr, Zn and Ca, and x=0.01 to 0.1), LiNi₁₋ₓMₓO₂ (wherein M is at least one selected from the group consisting of Co, Fe and Ga, and x=0.01 to 0.2), LiFeO₂, Fe₂(SO₄)₃, LiCo₁₋ₓMₓO₂ (wherein M is selected from the group consisting of Ni, Fe and Mn, and x=0.01 to 0.2), LiNi₁₋ₓMₓO₂ (wherein M is at least one selected from the group consisting of Mn, Fe, Co, Al, Ga, Ca and Mg, and x=0.01 to 0.2), Fe(MoO₄)₃, FeF₃, LiFePO₄, LiMnPO₄, and the like. Any of the above materials may be contained alone or in combination of two or more. In the positive electrode active material particles 42, lithium ions are desorbed in charging process, and lithium ions desorbed from the negative electrode active material particles in the negative electrode mixture layer 60 are inserted in discharging process.

Since the positive electrode active material particles 42 are generally oxide based and have high electrical resistance, the positive electrode conductive agent 43 for compensating electrical conductivity is used. Examples of the positive electrode conductive agent 43 include carbon materials such as acetylene black, carbon black, graphite, and amorphous carbon. Alternatively, oxide particles showing electronic conductivity such as indium.tin oxide (ITO) or antimony.tin oxide (ATO) can be also used.

Since both the positive electrode active material particles 42 and the positive electrode conductive agent 43 are normally powders, it is preferable that a positive electrode binder having binding ability to the powder is mixed and the powders are bonded to each other and simultaneously adhered to the positive electrode current collector 10. Examples of the positive electrode binder include styrene-butadiene rubber, carboxymethyl cellulose, polyvinylidene fluoride (PVDF), mixtures thereof, and the like.

<Positive Electrode Current Collector>

As the positive electrode current collector 10, an aluminum foil with a thickness of 10 to 100 μm, an aluminum perforated foil with a thickness of 10 to 100 μm and a pore diameter of 0.1 to 10 mm, an expanded metal, a foamed metal plate, or the like is used.

<Positive Electrode>

The positive electrode slurry obtained by mixing the positive electrode active material particles 42, the positive electrode conductive agent 43, the positive electrode binder, and an organic solvent is attached to the positive electrode current collector 10 by a doctor blade method, a dipping method, a spray method, or the like. Thereafter, the organic solvent is dried, and the resulting materials are pressure-molded by roll pressing, whereby the positive electrode 70 can be prepared. In addition, it is also possible to laminate a plurality of positive electrode mixture layers 40 on the positive electrode current collector 10, by performing the steps from coating to drying plural times.

<Negative Electrode Mixture Layer>

As shown in FIG. 3, the negative electrode mixture layer has negative electrode active material particles 62, a negative electrode conductive agent 63 which can be optionally contained, and a negative electrode binder which can be optionally contained.

It is desirable to use graphite as the negative electrode active material particles 62. Graphite has an average interlayer spacing of (002) plane measured by X-ray diffraction method of 0.3400 nm or less. Also, the particle size (d50) of the graphite is 0.5 μm to 10 μm. By using the graphite, the resistance to electrolyte solution reduction of a film formed by the reaction of the additive of the present invention is improved, and the irreversible capacity is reduced. Also, since the film formed is high in ionic conductivity, it is thought that the resistance of the Li battery is also reduced.

Moreover, as the negative electrode active material particles 62, in addition to graphite, a metal alloyed with lithium or a material having a metal supported on the surfaces of carbon particles can also be used. For example, a metal selected from lithium, silver, aluminum, tin, silicon, indium, gallium and magnesium or an alloy is used. Further, the metal or an oxide of the metal can be used as a negative electrode active material. Furthermore, it is also possible to use lithium titanate.

Examples of the negative electrode conductive agent 63 include carbon materials such as acetylene black, carbon black, graphite, and amorphous carbon, and the like.

Since both the negative electrode active material particles 62 and the negative electrode conductive agent 63 are normally powders, it is preferable that a binder having binding ability to the powder is mixed, and the powders are bonded to each other and simultaneously adhered to the negative electrode current collector 20. Examples of the negative electrode binder include styrene-butadiene rubber, carboxymethyl cellulose, polyvinylidene fluoride (PVDF), mixtures thereof, and the like.

<Negative Electrode Current Collector>

The negative electrode current collector 20 is electrically connected to the negative electrode mixture layer 60. As the negative electrode current collector 20, a metal foil with a thickness of 10 μm to 100 μm can be used. It is desirable that the material is a metal that does not form an alloy with lithium and is not reduced even by an operating potential of the negative electrode (<2.5 V vs. Li/Li+). Specific examples thereof include noble metals such as gold and indium, copper, titanium, nickel, and the like. Among them, copper has advantages such as light weight, low cost compared with others, and excellent durability.

The shape of the negative electrode current collector 20 is desirably a porous shape in addition to a flat thin film shape, similar to the positive electrode current collector 10. Examples thereof include a perforated foil having through holes, an expanded metal, or a foamed metal plate. Also included are those in which the surfaces of these foils and boards are etched by an appropriate method to roughen the surface. By adopting a configuration in which the electrode material is filled in such holes, it is possible to obtain a battery having low battery resistance and no drop in battery capacity for charge and discharge cycles.

<Negative Electrode>

The negative electrode slurry obtained by mixing the negative electrode active material particles 62, the negative electrode conductive agent 63, and an organic solvent containing a small amount of water is attached to the negative electrode current collector 20 and the negative electrode surface of the interconnector 90 by a doctor blade method, a dipping method, a spray method, or the like. Thereafter, the organic solvent is dried, and the resulting materials are pressure-molded by roll pressing, whereby a negative electrode can be prepared. In addition, it is also possible to laminate a plurality of negative electrode mixture layers 60 on the negative electrode current collector 20 and the interconnector 90 by performing the steps from coating to drying plural times.

<Solid Electrolyte Layer>

The solid electrolyte layer 50 includes nanoparticles 51, glyme 52, an imide-based Li electrolyte salt 53, an optional binder 54, and an additive 55. The solid electrolyte layer 50 is prepared by mixing the glyme 52 and the imide-based Li electrolyte salt 53, further adding the nanoparticles 51 and the binder 54 thereto, stirring the mixture, and then processing into a sheet.

For the components of the nanoparticles 51, oxides such as SiO₂ and Al₂O₃ are used. The particle size of the nanoparticles is preferably 0.1 nm or more and 100 nm or less, and particularly preferably 1 nm or more and 20 nm or less. By controlling the particle size, retentivity of the liquid component is increased, thus an electrolyte having a stable shape can be prepared. The method of measuring the particle size of the nanoparticles 51 is a laser diffraction method.

The basic structure of the glyme 52 is expressed by formula (1).

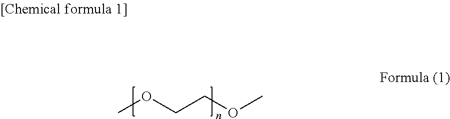

In the formula (1), n is an integer of 1 or more, preferably 2 or more and 6 or less, and particularly preferably 3 or more and 4 or less. By adjusting the number n, a solid electrolyte layer 50 with good ionic conductivity can be prepared.

The imide-based Li electrolyte salt 53 is desirably a material having a high degree of dissociation, high ionic conductivity, and high heat resistance. Specifically, LiTFSI, LiBETI, LiFSI or the like is suitably used.

As the binder 54, a fluorine-based resin is suitably used. PVDF or PTFE is suitably used as the fluorine-based resin. By using PVDF or PTFE, the adhesion between the solid electrolyte layer 50 and the electrode current collector is improved, so that the battery performance is improved.

The parts by weight of the nanoparticles 51, the glyme 52, the imide-based Li electrolyte salt 53, and the binder 54 are important for improving battery characteristics. The parts by weight of each material are obtained by measuring the weight of each material and expressing its ratio.

The nanoparticles 51 are desirably 10 parts by weight or more and 45 parts by weight or less, with respect to the total weight of materials contained in the solid electrolyte layer 50. When the number of the nanoparticles 51 is small, the strength of the solid electrolyte layer 50 may decrease. On the other hand, when the number of the nanoparticles 51 is large, the ionic conductivity decreases, so that the internal resistance of the battery may increase.

The glyme 52 is desirably 10 parts by weight or more and 40 parts by weight or less, with respect to the total weight of materials contained in the solid electrolyte layer 50. When the amount of the glyme 52 is small, the ionic conductivity may decrease. In addition, when the amount of the glyme 52 is large, the glyme 52 oozes out from the solid electrolyte layer 50, so that there is a possibility of liquid leakage of the liquid component.

The imide-based Li electrolyte salt 53 is desirably 20 parts by weight or more and 50 parts by weight or less, with respect to the total weight of materials contained in the solid electrolyte layer 50. When the amount of the imide-based Li electrolyte salt 53 is small, the negative electrode active material particles 62 may be adversely affected and the battery performance may be deteriorated. When the amount of the imide-based Li electrolyte salt 53 is large, the ionic conductivity may decrease.

The binder 54 is desirably 1 part by weight or more and 15 parts by weight or less, with respect to the total weight of materials contained in the solid electrolyte layer 50. When the amount of the binder 54 is small, the strength of the solid electrolyte layer 50 is lowered, so that it may be difficult to prepare the battery. On the other hand, when the amount of the binder 54 is large, the ionic conductivity decreases, so that the internal resistance of the battery may increase.

Corrosion of a current collector of Al can be suppressed by containing a specific additive 55 in the solid electrolyte layer 50. The following additives 55 may be used singly or plural types may be used.

<First Additive>

The first additive is represented by formula (2), and the cation of the formula (2) is represented by (M-R)⁺. M is consisted of any one of nitrogen (N), boron (B), phosphorus (P) and sulfur (S), and R is composed of a hydrocarbon group. Also, BF₄₋ and PF₆⁻ are preferably used as the anion of the formula (2). The corrosion of the current collector of Al can be suppressed efficiently by setting the anion of the first additive to BF₄⁻ and PF₆⁻. It is thought that this is because the F anion of BF₄⁻ and PF₆⁻ reacts with Al to form a passive film. These first additives may be used singly or plural types may be used.

[Expression 2]

(M−R)⁺Aₙ⁻ Formula (2)

The added amount of the first additive to be added is preferably 0.1 parts by weight or more and 20 parts by weight or less, and more preferably 0.5 parts by weight or more and 10 parts by weight or less, with respect to the total weight of materials contained in the solid electrolyte layer 50. When the added amount of the first additive is small, the effect of suppressing corrosion of Al may decrease. In addition, when the added amount of the first additive is large, conduction of Li ions is inhibited, so that the internal resistance of the battery may increase.

<Second Additive>

Additives other than the first additive can also be used as the second additive. Examples of the second additive include vinylene carbonate, fluoroethylene carbonate, 1,3-propane sultone, 1-propene 1,3-sultone, ethylene sulfate, and derivatives thereof. Since these second additives react at a positive electrode, the corrosion resistance of Al is further improved. These second additives may be used singly or plural types may be used.

The added amount of the second additive is preferably 0.01 parts by weight or more and 5 parts by weight or less, with respect to the total weight of materials contained in the solid electrolyte layer 50. When the added amount of the second additive is small, the reaction amount at a positive electrode may be reduced. In addition, when the added amount of the second additive is large, the amount of reaction at the positive electrode becomes excessive, the corrosion effect of the Al current collector of the first additive may be hindered, and the battery performance may be deteriorated.

The Li battery found in the present application can provide a highly safe and low cost Li battery because it has high heat resistance and can use an inexpensive Al current collector. Therefore, since the cooling mechanism of the battery can be also simplified, it is useful not only for small batteries for portable devices but also for large batteries for vehicles and the like.

Hereinafter, the present invention will be described more specifically with reference to examples, but the present invention is not limited to these examples. The results of the examples are summarized in Table 1.

### Example 1

<Method for Preparing Solid Electrolyte Layer>

A solid electrolyte layer 50 was prepared by using one which n=4 in formula 1 in the glyme 52, LiTFSI in the imide-based Li electrolyte salt 53, SiO₂ with an average particle size of 5 nm in the nanoparticles 51, and PTFE in the binder 54. The composition of the solid electrolyte layer 50 was 27 parts by weight of glyme, 37 parts by weight of LiTFSI, 32 parts by weight of SiO₂, and 3 parts by weight of PTFE. An additive of formula (3) was added to the composition, thereby preparing the solid electrolyte layer 50. The added amount of the formula (3) was 4 parts by weight.

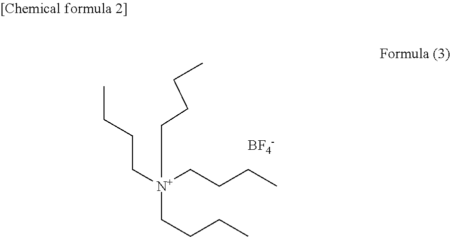 [SMILES: CCCC[N+](CCCC)(CCCC)CCCC ; "BF4-"]

<Measurement Method of Corrosion Current of Aluminum>

The prepared solid electrolyte was sandwiched between Al having an electrode area of 1 cm² and Li metal as a counter electrode to prepare an evaluation cell. Therein, the potential was swept from a potential range of 3.0 V to 5.5 V at a scanning potential of 5 mV/sec, and the current value (A/cm²) with respect to the potential was measured. The current value of 4.3 V was defined as the corrosion current of Al.

<Preparation Method of Positive Electrode>

A positive electrode active material (LiMn_{1/3}Co_{1/3}Ni_{1/3}O₂), a conductive agent (SP270: graphite manufactured by Nippon Graphite Industries, Co., Ltd.), PTFE and a solid electrolyte were mixed at a ratio of % by weight of 40:10:10:40, added to N-methyl-2-pyrrolidone and mixed to prepare a slurry-like solution. The slurry was applied to an aluminum foil with a thickness of 20 μm by a doctor blade method, and dried. The mixture was pressed so that the bulk density became 1.5 g/cm³ to prepare a positive electrode.

<Preparation Method of Negative Electrode>

As the negative electrode active material, Li metal was used. For the Li metal, one in which a surface was polished to remove impurities such as lithium carbonate was used.

<Preparation Method and Evaluation Method of Battery>

A solid electrolyte was inserted between the positive electrode and the negative electrode and laminated. Thereafter, the laminate was inserted into an aluminum laminate to form a battery. The battery was charged and discharged at a current density of 1.0 m A/cm² in a voltage range of 3.0 V to 4.2 V. The ratio of the capacities of the first cycle and the tenth cycle was defined as the capacity retention rate.

The corrosion current of Al was 7.0×10⁻⁶ A/cm², and the capacity retention rate obtained as a result of battery evaluation was 85%.

### Example 2

The same procedure was carried out as in Example 1 except that the added amount of the additive was changed to 0.5 parts by weight in Example 1. The corrosion current of Al was 12×10⁻⁶ A/cm⁻², and the capacity retention rate obtained as a result of battery evaluation was 84%.

### Example 3

The same procedure was carried out as in Example 1 except that the added amount of the additive was changed to 10 parts by weight in Example 1. The corrosion current of Al was 10×10⁻⁶ A/cm⁻², and the capacity retention rate obtained as a result of battery evaluation was 80%.

### Example 4

The same procedure was carried out as in Example 1 except that formula (4) was used as the additive in Example 1. The corrosion current of Al was 9.0×10⁻⁶ A/cm⁻², and the capacity retention rate obtained as a result of battery evaluation was 78%.

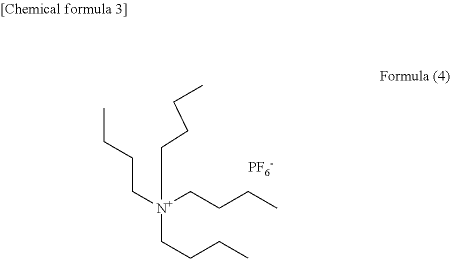

### Example 5

The same procedure was carried out as in Example 1 except that 1.0 part by weight of vinylene carbonate (VC) was added as the second additive in Example 1. The corrosion current of Al was 6.5×10⁻⁶ A/cm⁻², and the capacity retention rate obtained as a result of battery evaluation was 83%.

### Example 6

The same procedure was carried out as in Example 1 except that 1.0 part by weight of 1-propene 1,3-sultone (PS) was added as the second additive in Example 1. The corrosion current of Al was 6.4×10⁻⁶ A/cm⁻², and the capacity retention rate obtained as a result of battery evaluation was 82%.

### Example 7

The same procedure was carried out as in Example 1 except that 1.0 part by weight of fluoroethylene carbonate (FEC) was added as the second additive in Example 1. The corrosion current of Al was 6.8×10⁻⁶ A/cm⁻², and the capacity retention rate obtained as a result of battery evaluation was 84%.

### Comparative Example 1

The same procedure was carried out as in Example 1 except that the additive was not added in Example 1. The corrosion current of Al was 15×10⁻⁶ A/cm², and the capacity retention rate obtained as a result of battery evaluation was 65%.

### Comparative Example 2

The same procedure was carried out as in Example 5 except that the formula (2) was not added in Example 5. The corrosion current of Al was 14×10⁻⁶ A/cm⁻², and the capacity retention rate obtained as a result of battery evaluation was 66%.

### Comparative Example 3

The same procedure was carried out as in Example 6 except that the formula (2) was not added in Example 6. The corrosion current of Al was 14×10⁻⁶ A/cm⁻², and the capacity retention rate obtained as a result of battery evaluation was 63%.

### Comparative Example 4

The same procedure was carried out as in Example 7 except that the formula (2) was not added in Example 7. The corrosion current of Al was 13×10⁻⁶ A/cm⁻², and the capacity retention rate obtained as a result of battery evaluation was 60%.

| | | | Addition ratio of | | | |
|---|---|---|---|---|---|---|
| | | | additive to solid | | | |
| | | | electrolyte/parts | | Corrosion | |
| | Type of additive | | by weight | | current of Al | Capacity |
| | First | Second | First | Second | (×10⁻⁶/ | retention |
| | additive | additive | additive | additive | Acm⁻²) | rate (%) |
| Example 1 | Formula 3 | — | 4.0 | — | 7.0 | 85 |
| Example 2 | Formula 3 | — | 0.5 | — | 12.0 | 84 |
| Example 3 | Formula 3 | — | 10.0 | — | 10.0 | 80 |
| Example 4 | Formula 4 | — | 4.0 | — | 9.0 | 78 |
| Example 5 | Formula 3 | VC | 4.0 | 1.0 | 6.5 | 83 |
| Example 6 | Formula 3 | PS | 4.0 | 1.0 | 6.4 | 82 |
| Example 7 | Formula 3 | FEC | 4.0 | 1.0 | 6.8 | 84 |
| Comparative | — | — | — | — | 15.0 | 65 |
| Example 1 | | | | | | |
| Comparative | — | VC | — | 1.0 | 14.0 | 66 |
| Example 2 | | | | | | |
| Comparative | — | PS | — | 1.0 | 14.0 | 63 |
| Example 3 | | | | | | |
| Comparative | — | FEC | — | 1.0 | 13.0 | 60 |
| Example 4 | | | | | | |

It could be confirmed that, by adding the first additive to the solid electrolyte layer as in Examples 1 to 4, the corrosion current of AL was reduced and the capacity retention rate could be improved, as compared to Comparative Example 1. It could be confirmed that, by adding the second additive to the solid electrolyte layer in addition to the first additive as in Examples 5 to 7, the corrosion current of AL was reduced and the capacity retention rate could be improved, as compared to Comparative Examples 2 to 4.

### REFERENCE SIGNS LIST

10 Positive electrode current collector
20 Negative electrode current collector
30 Battery case
40 Positive electrode mixture layer
42 Positive electrode active material particles
43 Positive electrode conductive agent
50 Solid electrolyte layer
51 Nanoparticles
52 Glyme
53 Imide-based Li electrolyte salt
54 Binder
55 Additive
60 Negative electrode mixture layer
62 Negative electrode active material particles
63 Negative electrode conductive agent
70 Positive electrode
80 Negative electrode
90 Interconnector
100 All-solid battery
200 Bipolar all-solid battery

1. A solid electrolyte comprising an imide-based Li electrolyte salt, nanoparticles, glyme, and a first additive, wherein
the first additive is represented by formula (1)
[Expression 1]
(M−R)⁺Aₙ⁻ Formula (1)
wherein
M is any element of nitrogen (N), boron (B), phosphorus (P) and sulfur (S),
R is a hydrocarbon group, and
Aₙ is BF₄⁻ or PF₆⁻.

2. The solid electrolyte according to claim 1, wherein
the solid electrolyte comprises a second additive, and
the second additive is one or more of vinylene carbonate, fluoroethylene carbonate, 1,3-propane sultone, 1-propene 1,3-sultone, ethylene sulfate, and derivatives thereof.

3. The solid electrolyte according to claim 1, wherein
the glyme is represented by formula (2) 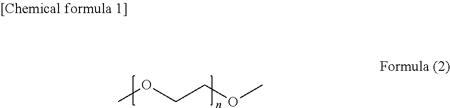
and n is 3 or more and 4 or less.

4. The solid electrolyte according to claim 1, wherein
the added amount of the first additive is 0.1 parts by weight or more and 20 parts by weight or less, with respect to the total weight of materials contained in the solid electrolyte.

5. The solid electrolyte according to claim 2, wherein
the added amount of the second additive is 0.01 parts by weight or more and 5 parts by weight or less, with respect to the total weight of materials contained in the solid electrolyte.

6. The solid electrolyte according to claim 1, wherein
the average particle size of the nanoparticles is 0.1 nm or more and 100 nm or less.

7. An all-solid battery comprising the solid electrolyte as defined in claim 1, a positive electrode, and a negative electrode.
